(19) United States
(12) Patent Application Publication
(10) Pub. No.: US 2025/0058771 A1
(43) Pub. Date: Feb. 20, 2025

(54) METHOD FOR OPERATING AN AUTONOMOUS VEHICLE TO AVOID COLLISONS

(71) Applicant: Torc Robotics, Inc., Blacksburg, VA (US)

(72) Inventor: Fridtjof Stein, Ostfildern (DE)

(21) Appl. No.: 18/806,505

(22) Filed: Aug. 15, 2024

(30) Foreign Application Priority Data
Aug. 16, 2023 (DE) 102023121946.4

(51) Int. Cl. B60W 30/09; B60R 21/0134; B60W 30/095; B60W 60/00

(52) U.S. Cl. CPC B60W 30/09; B60R 21/0134; B60W 30/0956; B60W 60/0011; B60W 60/0015; B60W 2554/4042

(57) ABSTRACT

A method for operating an autonomous vehicle with a sensor system and a computing unit connected thereto. The method includes detecting with the sensor system an environment of the vehicle and potential collision causes. The method includes detecting an impending collision of the potential collision causes. The method includes preparing an evasive strategy including an evasive trajectory in which the evasive trajectory with the lowest risk is selected from a family of evasive trajectories; and is carried out by the vehicle, wherein once the speed of the potential collision cause has fallen to about zero, the evasive movement of the vehicle is interrupted.

### CROSS-REFERENCE TO RELATED APPLICATIONS

This application claims priority to DE Patent Application No. 102023121946, filed Aug. 16, 2023, and titled “AUTONOMOUS TRUCKS—COLLISION AVOIDANCE BEHAVIOR WHILE STATIONARY”, which is hereby incorporated by reference in its entirety.

### BACKGROUND

The field of disclosure relates to a method for operating an autonomous vehicle to avoid collisions, and more particularly, for operating an autonomous vehicle in order to react to another vehicle that is on a collision course when the autonomous vehicle is stationary.

When an autonomous vehicle is stationary, it is in a safe state. It is intended to detect when another vehicle is approaching on a collision course while the autonomous vehicle is stationary.

US 2023/0150538 A1 describes systems and methods for situational behavior of an autonomous vehicle. In one aspect, an autonomous vehicle comprises at least one perception sensor configured to generate perception data indicative of at least one other vehicle on a road, a non-transitory computer-readable medium, and a processor. The processor is configured to use the perception data to determine that the other vehicle is violating one or more traffic laws, to mark the other vehicle as a non-compliant driver, and to modify control of the autonomous vehicle in response to marking the other vehicle as a non-compliant driver.

Thus, it is desirable to provide a method for operating an autonomous vehicle to avoid collisions.

### BRIEF DESCRIPTION

In one aspect, a method for operating an autonomous vehicle with a sensor system and a computing unit connected thereto. The method includes detecting with the sensor system an environment of the vehicle and potential collision causes. The method includes detecting an impending collision of the potential collision causes. The method includes preparing an evasive strategy including an evasive trajectory in which the evasive trajectory with the lowest risk is selected from a family of evasive trajectories; and is carried out by the vehicle, wherein once the speed of the potential collision cause has fallen to about zero, the evasive movement of the vehicle is interrupted.

In another aspect, a method for operating an autonomous vehicle with a sensor system and a computing unit connected thereto. The method includes detecting with the sensor system an environment of the vehicle and potential collision causes. The method includes detecting an impending collision of the potential collision causes. The method includes preparing an evasive strategy including an evasive trajectory in which the evasive trajectory with the lowest risk is selected from a family of evasive trajectories; and is carried out by the vehicle, wherein once the speed of the potential collision cause has fallen to about zero, the evasive movement of the vehicle is interrupted, wherein a continuous recalculation and adaptation occurs during the execution of the evasive trajectory.

In another aspect, a method for operating an autonomous vehicle with a sensor system and a computing unit connected thereto. The method includes detecting with the sensor system an environment of the vehicle and potential collision causes. The method includes detecting an impending collision of the potential collision causes by detecting illuminated reversing lights or the switching on of reversing lights or by tracking and detecting an uncontrolled movement. The method includes preparing an evasive strategy including an evasive trajectory in which the evasive trajectory with the lowest risk is selected from a family of evasive trajectories; and is carried out by the vehicle, wherein once the speed of the potential collision cause has fallen to about zero, the evasive movement of the vehicle is interrupted.

The solution according to the present disclosure can prevent accidents caused by third parties or reduce the damage caused by them. By simultaneously recording the sensor information and the decision-making process, legal documentation is also available.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an autonomous vehicle with a sensor system for environmental detection and an associated computing unit,

FIG. 2 is a schematic view of an autonomous vehicle formed as a commercial vehicle combination with a sensor system for environmental detection and a computing unit connected thereto,

FIG. 3 is a schematic view of an autonomous vehicle with an extendable protective device in the retracted state,

FIG. 4 is a schematic view of the autonomous vehicle with the extendable protective device in the extended state,

FIG. 5 is a schematic view of an exemplary processing chain of the autonomous vehicle,

FIG. 6 is a schematic view of an exemplary scenario in which the vehicle is on a sloping, slippery roadway with a potential collision cause moving downhill towards the vehicle,

FIG. 7 is a schematic view of an internal map of the vehicle with the measured environment,

FIG. 8 is a schematic view of the internal map with multiple possible evasive trajectories with associated risk assessments,

FIG. 9 is a schematic view of the scenario in which the potential collision causer has moved further towards the vehicle, with the vehicle making an evasive movement on the evasive trajectory with the lowest risk,

FIG. 10 is a schematic view of an exemplary scenario in which the vehicle, a commercial vehicle combination with a tractor and a trailer or semitrailer, is on a sloping, slippery roadway, wherein a potential collision cause is moving downhill towards the vehicle,

FIG. 11 is a schematic view of an internal map of the vehicle with the measured environment,

FIG. 12 is a schematic view of the internal map with several possible evasive trajectories with associated risk assessments,

FIG. 13 is a schematic view of the scenario in which the potential collision cause has moved further towards the vehicle, wherein the vehicle makes an evasive movement on the evasive trajectory with the lowest risk,

FIG. 14 is a schematic view of an exemplary scenario in which the vehicle, a commercial vehicle combination with a tractor and a trailer or semitrailer is on a sloping, slippery roadway surrounded by obstacles with a potential collision cause moving downhill towards the vehicle,

FIG. 15 is a schematic view of an internal map of the vehicle with the measured environment,

FIG. 16 is a schematic view of the internal map with only one possible evasive trajectory with associated risk assessment,

FIG. 17 is a schematic view of the scenario in which the potential collision cause has continued to move towards the vehicle, while the vehicle remained stationary,

FIG. 18 is a schematic view of an exemplary scenario in which the vehicle is on a sloping, slippery roadway, wherein a potential collision cause is moving downhill towards the vehicle, which is provided with a protective device,

FIG. 19 is a schematic view of an internal map of the vehicle with the measured environment,

FIG. 20 is a schematic view of the internal map, wherein the extendable protective device is extended,

FIG. 21 is a schematic view of the scenario in which the potential collision cause has moved further towards the vehicle, wherein the vehicle is being controlled to intercept the potential collision cause and

FIG. 22 is a schematic view of the vehicle and of the potential collision cause with respective vehicle coordinate systems.

Corresponding parts are provided with the same reference numerals in all figures.

### DETAILED DESCRIPTION

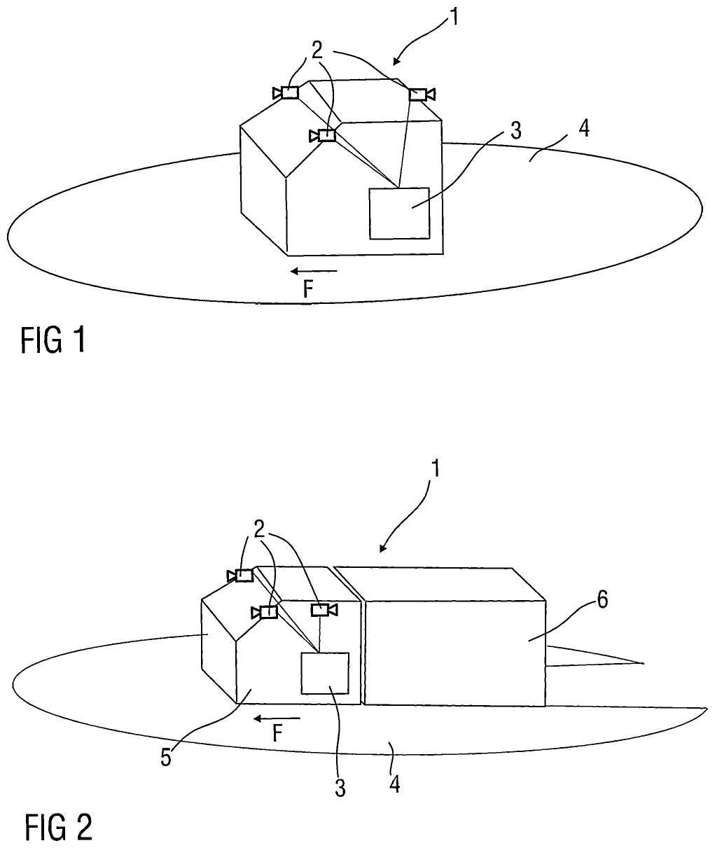

FIG. 1 is a schematic view of an autonomous vehicle with a sensor system 2 for environmental detection and an associated computing unit 3. The sensor system 2 can, for example, have at least one camera and/or at least one radar sensor and/or at least one LIDAR sensor and/or at least one ultrasonic sensor. Furthermore, a detection region 4 of the sensor system 2 is shown.

The autonomous vehicle 1 can be any type of vehicle, for example, a car, a truck, a bus or a tractor.

When the autonomous vehicle 1 is stationary or traveling at low speed (e.g., crawling speed), the surroundings of the vehicle 1 are detected by means of the sensor system 2. In this case, a potential cause of a collision can be detected, for example by detecting illuminated reversing lights or the switching on of reversing lights of a vehicle stationary in front of vehicle 1 in the direction of travel F. If an impending collision is detected, an evasive strategy can be calculated. From a set of evasive trajectories, the one with the lowest risk can be selected and executed by vehicle 1. At the same time, further protective measures, if available, can be initiated with the aim of reducing the consequences of a collision. For example, an extendable protective device 7 or an external airbag may be provided as a protective measure.

FIG. 2 is a schematic view of an autonomous vehicle 1 designed as a commercial vehicle combination with a sensor system 2 for detecting the environment and a computing unit 3 connected thereto. The sensor system 2 can, for example, have at least one camera and/or at least one radar sensor and/or at least one LIDAR sensor and/or at least one ultrasonic sensor. Furthermore, a detection region 4 of the sensor system 2 is shown.

The autonomous vehicle 1 has a tractor 5 and a trailer 6 or semi-trailer 6.

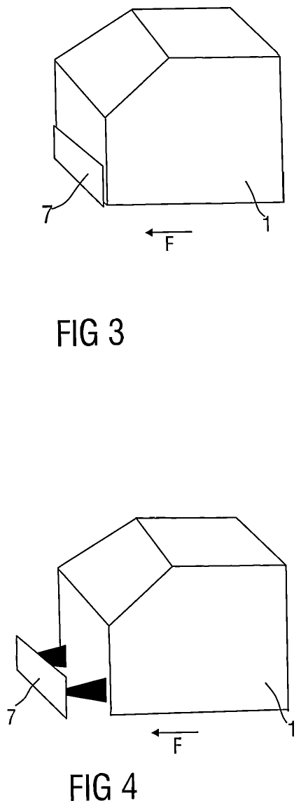

FIG. 3 is a schematic view of an autonomous vehicle 1 with an extendable protective device 7 in the retracted state.

FIG. 4 is a schematic view of the autonomous vehicle 1 with the extendable protective device 7 in the extended state. The protective device 7 can, for example, be a bumper.

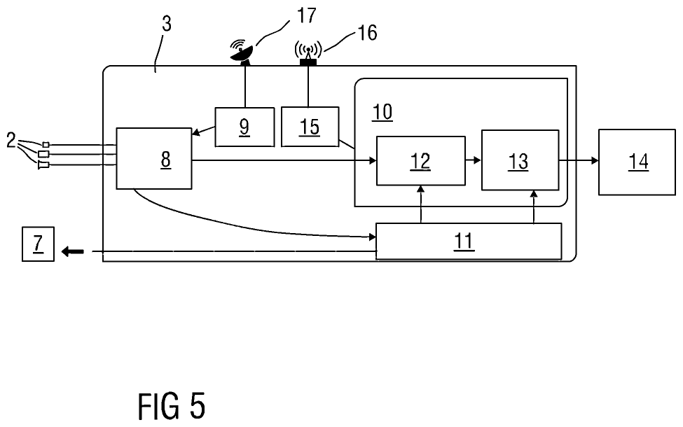

FIG. 5 is a schematic view of an exemplary processing chain of the autonomous vehicle 1. Environmental data is recorded by the sensor system 2 and fed to the computing unit 3. In the computing unit 3, the data from the sensor system 2 are fused in a fusion unit 8 and compensated and localized with an internal digital map 9. The fused data from the fusion module 8 are fed to a behavior planning module 10 and fed to an active collision avoidance module 11. The behavior planning module 10 has a situation analysis and planning module 12 and a trajectory generator 13 and is configured to control an actuator system 14 of the vehicle 1 for steering, accelerator and brake.

The digital map 9 can be connected to a satellite navigation system 17.

In the active collision avoidance module 11, when the autonomous vehicle 1 is stationary or traveling at low speed (e.g. crawling speed), potential collision partners are detected in the data from the fusion module 8, for example by detecting illuminated reversing lights or the switching on of reversing lights of a vehicle stationary in the direction of travel F in front of the vehicle 1. If an impending collision is detected, an evasive strategy can be calculated. A family of possible evasive trajectories can be generated in the trajectory generator 13, wherein the evasive trajectory with the lowest risk is selected by the situation analysis and planning module 12 and executed by the actuators 14. At the same time, the active collision avoidance module 11 can initiate further protective measures, for example extending the extendable protective device 7 or triggering the external airbag, with the aim of reducing the consequences of a collision.

The behavior planning module 10 can further communicate with a back end 16 via an interface 15, in particular wirelessly.

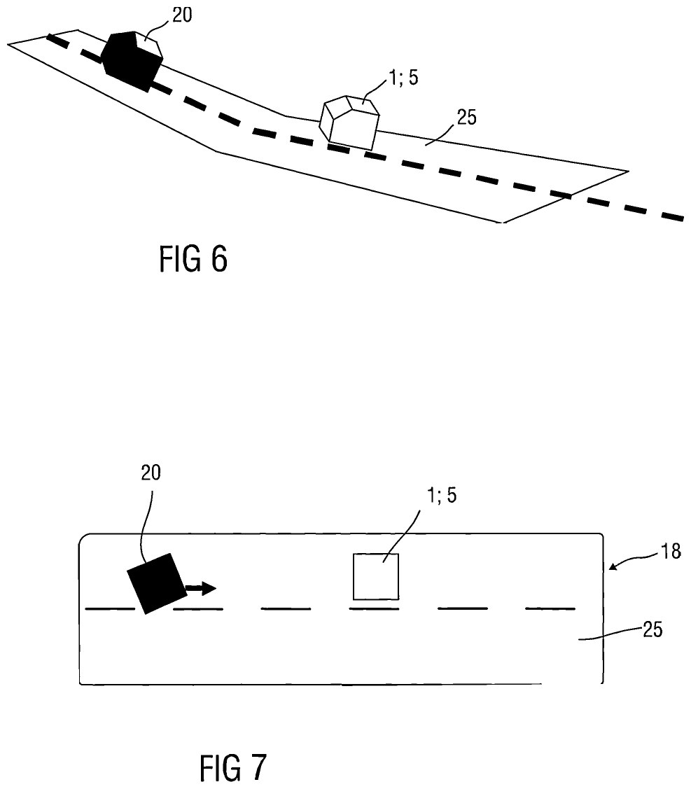

FIG. 6 is a schematic view of an exemplary scenario in which the vehicle 1, a tractor 5, is on a sloping, slippery roadway 25, wherein a potential collision cause 20 is moving downhill towards the vehicle 1, in particular in an uncontrolled direction.

FIG. 7 is a schematic view of an internal map 18 of the vehicle 1 with the measured environment.

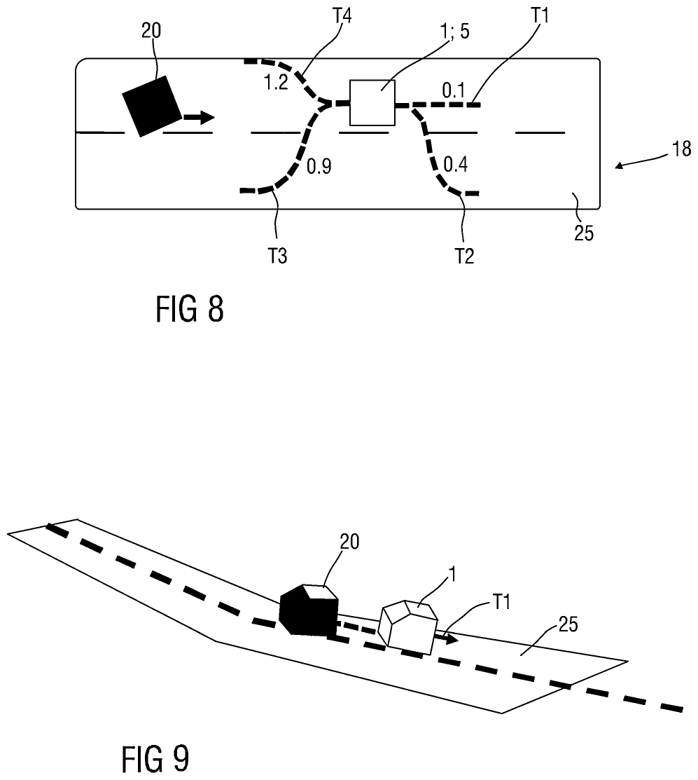

FIG. 8 is a schematic view of the internal map 18 with multiple possible evasive trajectories T1 to T4 with associated risk assessments, wherein smaller numbers represent the lowest risk.

FIG. 9 is a schematic view of the scenario in which the potential collision cause 20 has moved further towards the vehicle 1. The vehicle 1 executes an evasive maneuver on the evasive trajectory T1 with the lowest risk and drives backwards away from the potential collision cause 20. Continuous recalculation and adaptation can take place. As soon as the speed of the potential collision cause 20 has fallen to zero, the evasive maneuver of vehicle 1 is interrupted.

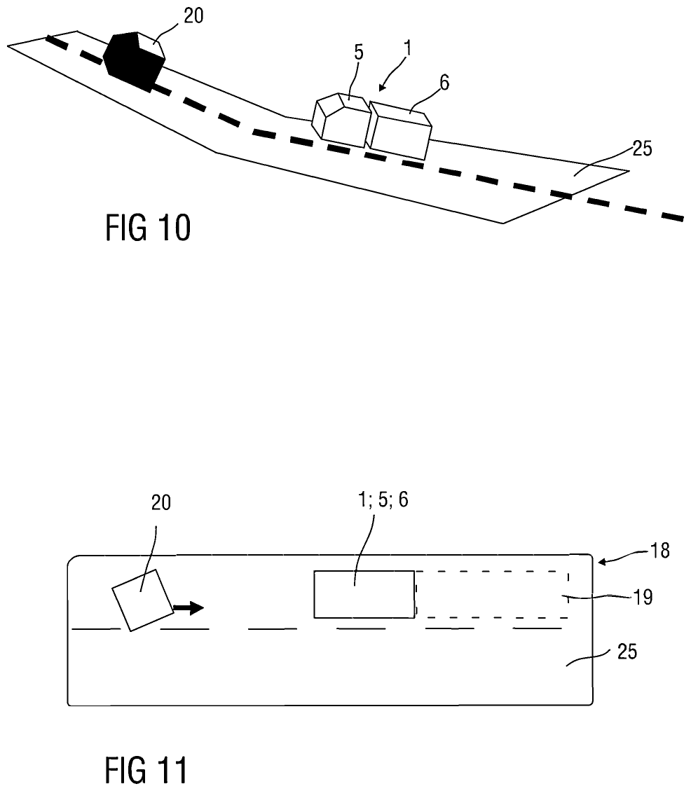

FIG. 10 is a schematic view of an exemplary scenario in which the vehicle 1, a commercial vehicle combination with a tractor 5 and a trailer 6 or semitrailer 6, is on a sloping, slippery roadway 25, wherein a potential collision cause 20 is moving downhill towards the vehicle 1, in particular with an uncontrolled direction.

FIG. 11 is a schematic view of an internal map 18 of the vehicle 1 with the measured environment. Because of the trailer 6 or semitrailer 6, there is a non-visible region 19 behind the vehicle 1.

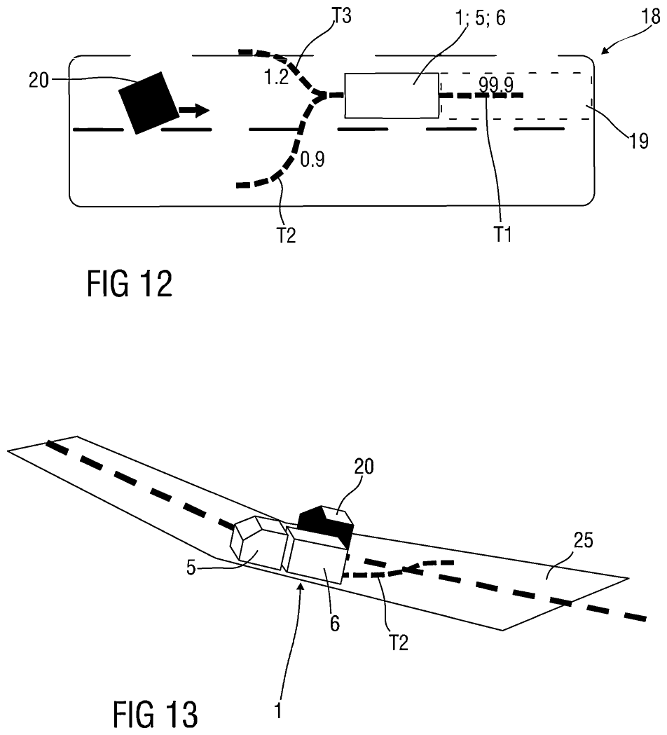

FIG. 12 is a schematic view of the internal map 18 with multiple possible evasive trajectories T1 to T3 with associated risk assessments, wherein smaller numbers represent the lowest risk. The evasive trajectory T1 runs through the non-visible region 19 and therefore has the highest risk.

FIG. 13 is a schematic view of the scenario in which the potential collision cause 20 has moved further towards the vehicle 1. Vehicle 1 executes an evasive maneuver on the evasive trajectory T2 with the lowest risk and drives towards the potential collision cause 20, but changes to the other lane. Continuous recalculation and adaptation can take place. As soon as the speed of the potential collision cause 20 has dropped to zero, the evasive maneuver is interrupted by the vehicle 1.

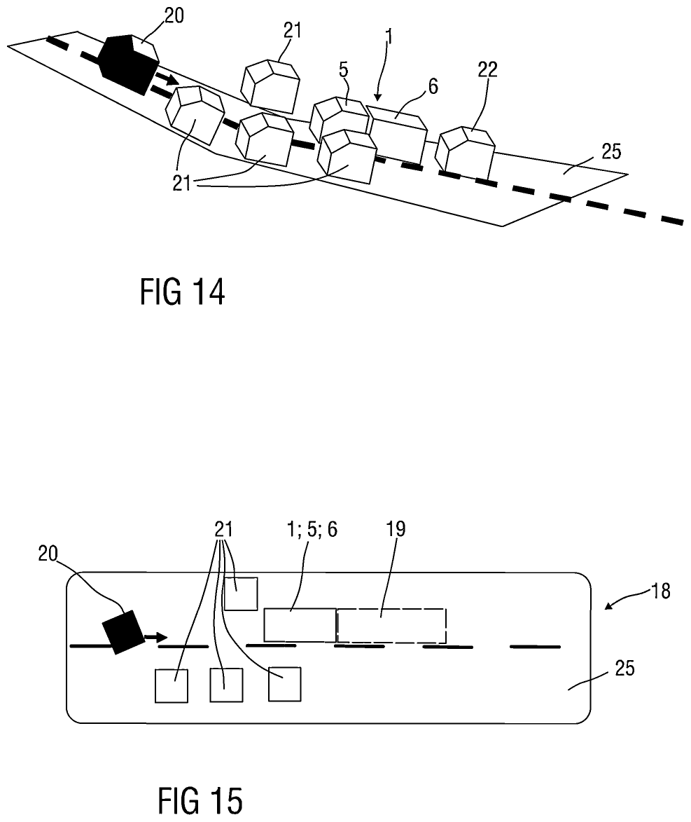

FIG. 14 is a schematic view of an exemplary scenario in which the vehicle 1, a commercial vehicle combination with a tractor 5 and a trailer 6 or semitrailer 6, is on a sloping, slippery roadway 25, wherein a potential collision cause 20 is moving downhill towards the vehicle 1, in particular with an uncontrolled direction. Next to and in front of vehicle 1 in the direction of travel F there are obstacles 21, for example other vehicles. Because of the trailer 6 or semitrailer 6, there is a non-visible region 19 behind the vehicle 1, in which a possible obstacle 22, for example another vehicle, could be located. However, this cannot be determined.

FIG. 15 is a schematic view of an internal map 18 of the vehicle 1 with the measured environment.

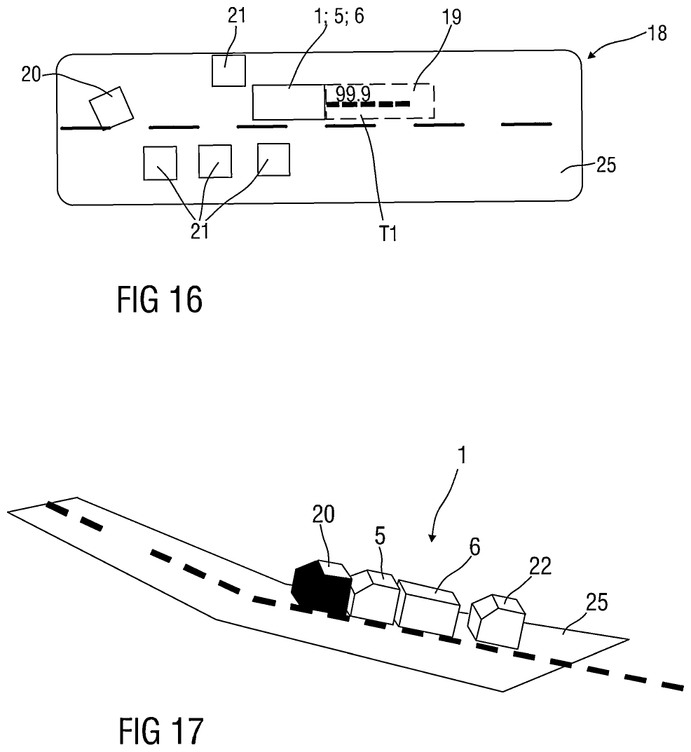

FIG. 16 is a schematic view of the internal map 18 with only one possible evasive trajectory T1 with associated risk assessment. The evasive trajectory T1 runs through the non-visible region 19 and therefore has the highest risk. Other evasive trajectories are not available due to the known obstacles 21. The behavior planning module 10 can execute different strategies depending on a speed of the potential collision cause 20, an expected time until collision, the type of the potential collision cause 20 (for example, car or tanker truck). For example, the vehicle 1 can slowly drive back on the evasive trajectory T1 in order to give the possible obstacle 22 (for example a vehicle) in the non visible region 19 the opportunity to drive back. Alternatively, vehicle 1 can remain stationary and face the collision.

FIG. 17 is a schematic view of the scenario in which the potential collision cause 20 has moved further towards the vehicle 1. Vehicle 1 has stopped.

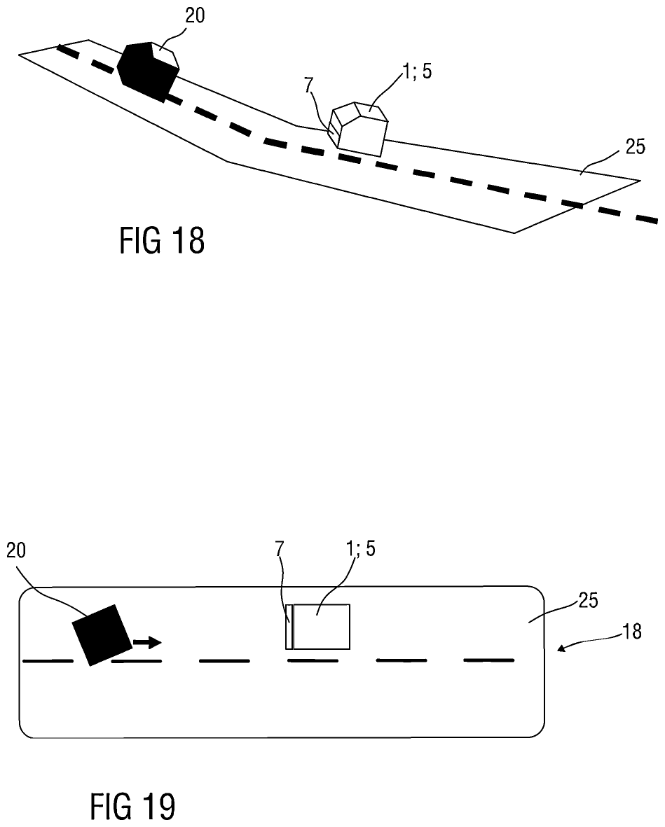

FIG. 18 is a schematic view of an exemplary scenario in which the vehicle 1, a tractor 5, is on a sloping, slippery roadway 25, wherein a potential collision cause 20 is moving downhill towards the vehicle 1, in particular in an uncontrolled direction. The vehicle 1 is equipped with an extendable protective device 7 according to FIGS. 3 and 4.

FIG. 19 is a schematic view of an internal map 18 of the vehicle 1 with the measured environment.

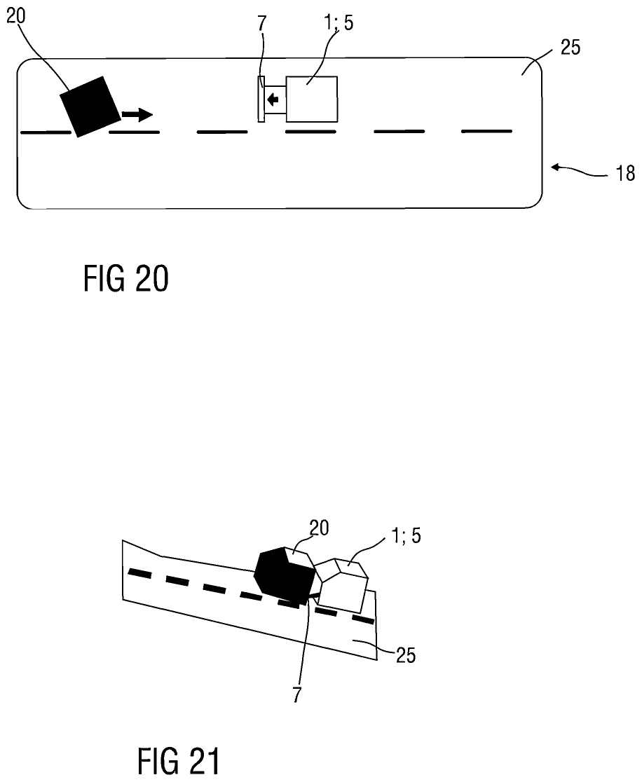

FIG. 20 is a schematic view of the internal map 18, wherein the extendable protective device 7 is extended. This brings the potential collision cause 20 to a controlled stop. Alternatively, the vehicle 1 can be controlled by the behavior planning module 10 in such a way that it intercepts the potential collision cause 20 by the vehicle 1 with the protective device 7 extended initially driving slowly backwards, i.e. in the same direction as the potential collision cause 20, continuing to drive at the same speed as the potential collision cause when the protective device 7 has come into contact with the potential collision cause 20 and then braking itself and the potential collision cause 20 in a controlled manner down to a standstill.

FIG. 21 is a schematic view of this scenario.

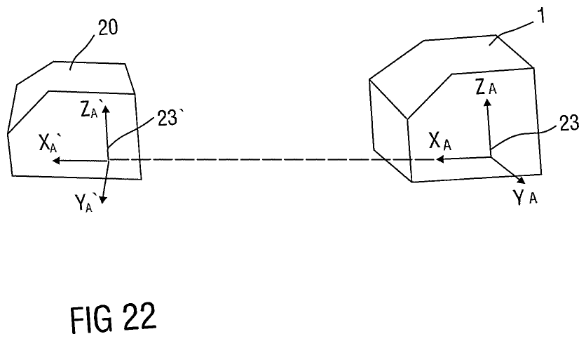

FIG. 22 is a schematic view of the vehicle 1 with the potential collision cause 20, a vehicle coordinate system 23 of the vehicle 1, which has its coordinate origin on a center of its rear axle and has the spatial directions X_{A}, Y_{A}, Z_{A}, and a vehicle coordinate system 23′ of the potential collision cause 20, which has its coordinate origin at the center of its rear axle and has the spatial directions X_{A}′, Y_{A}′, Z_{A}′.

In order to detect a road user moving in an uncontrolled manner, in particular the potential cause of collision 20, it is possible, thanks to LIDAR and/or camera technology (in particular stereo camera technology), to measure a road user, in particular the potential cause of collision 20, with sufficient lateral and vertical resolution so that a rough model can be fitted. If this road user moves in a direction other than the spatial direction+/−X_{A}, namely in the longitudinal direction or direction of travel F of vehicle 1, it can be assumed that it is moving in an uncontrolled manner. This may mean that the wheels of the road user, in particular of the potential collision cause 20, have no traction, for example due to a slippery ground surface. Another criterion for a road user moving uncontrollably may be that he or she is moving on a clothoid, which can be determined by tracking. Otherwise, it can be assumed that it is spinning.

1. A method for operating an autonomous vehicle with a sensor system and a computing unit connected thereto, the method comprising:
detecting with the sensor system an environment of the vehicle and potential collision causes,
detecting an impending collision of the potential collision cause, and
preparing an evasive strategy including an evasive trajectory in which the evasive trajectory with the lowest risk is selected from a family of evasive trajectories and is carried out by the vehicle, wherein once the speed of the potential collision cause has fallen to about zero, the evasive movement of the vehicle is interrupted.

2. The method according to claim 1, wherein the potential collision cause is detected by detecting illuminated reversing lights or the switching on of reversing lights or by tracking and detecting an uncontrolled movement.

3. The method according to claim 1, wherein upon detection of an impending collision, further protective measures are initiated with the aim of reducing the consequences of the collision, the further protective measures comprising extending an extendable protective device, triggering an external airbag, and combinations thereof.

4. The method according to claim 1, wherein a continuous recalculation and adaptation occurs during the execution of the evasive trajectory.

5. The method according to m claim 1, wherein an evasive trajectory that runs through a region not visible to the sensor system is assigned a particularly high risk.

6. The method according to claim 5, wherein if there is no alternative to the evasive trajectory located in the non-visible region, the vehicle slowly drives back on the evasive trajectory or remains stationary.

7. The method according to claim 1, wherein the vehicle intercepts the potential collision cause by driving the vehicle with a protective device extended initially slowly in the same direction as the potential collision cause, continuing to drive at the same speed and direction as the potential collision cause when the protective device comes into contact with the potential collision cause and then braking itself and the potential collision cause in a controlled manner to a standstill.

8. The method according to claim 2, wherein upon detection of an impending collision, further protective measures are initiated with the aim of reducing the consequences of the collision, the further protective measures comprising extending an extendable protective device, triggering an external airbag, and combinations thereof.

9. A method for operating an autonomous vehicle with a sensor system and a computing unit connected thereto, the method comprising:
detecting with the sensor system an environment of the vehicle and potential collision causes;
detecting an impending collision of the potential collision causes; and
preparing an evasive strategy including an evasive trajectory in which the evasive trajectory with the lowest risk is selected from a family of evasive trajectories; and is carried out by the vehicle, wherein once the speed of the potential collision cause has fallen to about zero, the evasive movement of the vehicle is interrupted,
wherein a continuous recalculation and adaptation occurs during the execution of the evasive trajectory.

10. The method according to claim 9, wherein the potential collision cause is detected by detecting illuminated reversing lights or the switching on of reversing lights or by tracking and detecting an uncontrolled movement.

11. The method according to claim 9, wherein upon detection of an impending collision, further protective measures are initiated with the aim of reducing the consequences of the collision, the further protective measures comprising extending an extendable protective device, triggering an external airbag, and combinations thereof.

12. The method according to claim 10, wherein upon detection of an impending collision, further protective measures are initiated with the aim of reducing the consequences of the collision, the further protective measures comprising extending an extendable protective device, triggering an external airbag, and combinations thereof.

13. The method according to claim 9, wherein an evasive trajectory that runs through a region not visible to the sensor system is assigned a particularly high risk.

14. The method according to claim 13, wherein if there is no alternative to the evasive trajectory located in the non-visible region, the vehicle slowly drives back on the evasive trajectory or remains stationary.

15. The method according to claim 9, wherein the vehicle intercepts the potential collision cause by driving the vehicle with a protective device extended initially slowly in the same direction as the potential collision cause, continuing to drive at the same speed and direction as the potential collision cause when the protective device comes into contact with the potential collision cause and then braking itself and the potential collision cause in a controlled manner to a standstill.

16. A method for operating an autonomous vehicle with a sensor system and a computing unit connected thereto, the method comprising:
detecting with the sensor system an environment of the vehicle and potential collision causes;
detecting an impending collision of the potential collision causes by detecting illuminated reversing lights or the switching on of reversing lights or by tracking and detecting an uncontrolled movement; and
preparing an evasive strategy including an evasive trajectory in which the evasive trajectory with the lowest risk is selected from a family of evasive trajectories; and is carried out by the vehicle, wherein once the speed of the potential collision cause has fallen to about zero, the evasive movement of the vehicle is interrupted.

17. The method according to claim 16, wherein upon detection of an impending collision, further protective measures are initiated with the aim of reducing the consequences of the collision, the further protective measures comprising extending an extendable protective device, triggering an external airbag, and combinations thereof.

18. The method according to claim 16, wherein upon detection of an impending collision, further protective measures are initiated with the aim of reducing the consequences of the collision, the further protective measures comprising extending an extendable protective device, triggering an external airbag, and combinations thereof.

19. The method according to claim 16, wherein upon detection of an impending collision, further protective measures are initiated with the aim of reducing the consequences of the collision, the further protective measures comprising extending an extendable protective device, triggering an external airbag, and combinations thereof.

20. The method according to claim 19, wherein the vehicle intercepts the potential collision cause by driving the vehicle with a protective device extended initially slowly in the same direction as the potential collision cause, continuing to drive at the same speed and direction as the potential collision cause when the protective device comes into contact with the potential collision cause and then braking itself and the potential collision cause in a controlled manner to a standstill.
